(19) United States
(12) Patent Application Publication
(10) Pub. No.: US 2007/0237275 A1
(43) Pub. Date: Oct. 11, 2007

(54) Method and apparatus for a time domain zero phase start using binary sampled data

(76) Inventors: Pervez M. Aziz, Dallas, TX (US); Gregory W. Sheets, Bangor, PA (US)

Correspondence Address: RYAN, MASON & LEWIS, LLP, 1300 POST ROAD, SUITE 205, FAIRFIELD, CT, 06824, US

(21) Appl. No.: 11/399,647

(22) Filed: Apr. 6, 2006

(51) Int. Cl. H04L 7/00

(52) U.S. Cl. 375/371

(57) ABSTRACT

Methods and apparatus are provided for obtaining a phase offset estimate from a data stream. A binary sampled version of the data stream is obtained based on a clock. A first dot product of the binary sampled version of the data stream and an ideal sequence and a second dot product of the binary sampled version of the data stream and a delayed ideal sequence are accumulated. A phase offset of the clock is adjusted until the accumulated first and second dot product satisfy one or more predefined conditions. For example, the predefined conditions can comprise a transition of at least one of the accumulated first and second dot product or whether at least one of the accumulated first and second dot product transition to a final value.

### FIELD OF THE INVENTION

The present invention relates generally to techniques for recovering a clock from a received data stream, and more particularly, to techniques for obtaining an initial phase estimate using a zero phase start algorithm.

### BACKGROUND OF THE INVENTION

For many clock/data recovery (CDR) applications, the initial CDR gain must be relatively low to provide good periodic jitter (PJ) tolerance. This must be balanced, however, with the need for a fast acquisition time. Generally, a reduction in the acquisition time comes at the expense of degrading PJ performance. Zero phase start (ZPS) techniques have been used to improve the acquisition time. Generally, ZPS algorithms obtain an initial estimate of the phase of the signal before the normal CDR operation commences. ZPS acquires the initial phase, typically using a “one shot” phase calculation based on accumulated digital samples of the signal. Traditional ZPS techniques have relied on relatively finely quantized amplitude domain signal samples from an analog-to-digital converter (ADC).

A number of receiver architectures have been proposed or suggested, however, that do not employ such analog-to-digital converters. Thus, the finely quantized amplitude domain signal samples that are required for ZPS algorithms are not available. A need exists for CDR systems that provide improved acquisition time. A further need exists for a time domain based zero phase start algorithm that does not require finely quantized amplitude domain signal samples.

### SUMMARY OF THE INVENTION

Generally, methods and apparatus are provided for obtaining a phase offset estimate from a data stream. According to one aspect of the invention, a binary sampled version of the data stream is obtained based on a clock. A first dot product of the binary sampled version of the data stream and an ideal sequence and a second dot product of the binary sampled version of the data stream and a delayed ideal sequence are accumulated. A phase offset of the clock is adjusted until the accumulated first and second dot product satisfy one or more predefined conditions. For example, the predefined conditions can comprise a transition of at least one of the accumulated first and second dot product or whether at least one of the accumulated first and second dot product transition to a final value.

The ideal sequence can be based on, for example, a shoulder sampling or a peak/zero crossing sampling of the data stream. The delayed ideal sequence can be delayed by one unit interval.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of a conventional serializer/deserializer communication channel;

FIG. 2 is a block diagram of a communication channel that employs a ZPS algorithm to obtain an initial estimate of the phase of the signal;

FIG. 3 illustrates the transmission of a preamble pattern before the actual data for a ZPS algorithm;

FIG. 4 illustrates the ZPS accumulator values w0[n] and w1[n] as a function of input phase for “shoulder” samples;

FIG. 5 illustrates the ZPS accumulator values w0[n] and w1[n] as a function of input phase for peak and zero-crossing samples;

FIG. 6 is a block diagram of a conventional serializer/deserializer communication channel having a channel impairment;

FIGS. 7 and 8 illustrate the ZPS accumulator values w0[n] and w1[n] as a function of the input phase for binary sliced input sample for shoulder samples and L equal to 8 and peak and zero samples and L equal to 16, respectively;

FIG. 9 is a block diagram of a time domain based ZPS calculation algorithm operating on binary samples in accordance with an embodiment of the present invention;

FIG. 10 is a sample ZPS lookup table that processes the values of w0[n] and w1][n] to determine when the ZPS process is complete;

FIG. 11 is a flow chart describing an exemplary implementation of the ZPS algorithm 900 incorporating features of the present invention

FIGS. 12 and 13 illustrate the ZPS accumulator values w0[n] and w1[n] as a function of the input phase in the presence of latch offsets for shoulder samples for 6 and 10% latch offsets, respectively; and

FIG. 14 is a sample ZPS lookup table that processes the values of w0[n] and w1[n] in the presence of latch offsets to determine when the ZPS process is complete.

### DETAILED DESCRIPTION

The present invention improves the acquisition time by using a time domain based zero phase start algorithm to obtain an initial estimate of the phase of the signal before the normal CDR operation commences. The disclosed time domain based zero phase start (ZPS) algorithm works with binary quantized/sliced amplitude samples of a 2T preamble sinusoidal pattern.

### ZPS Background

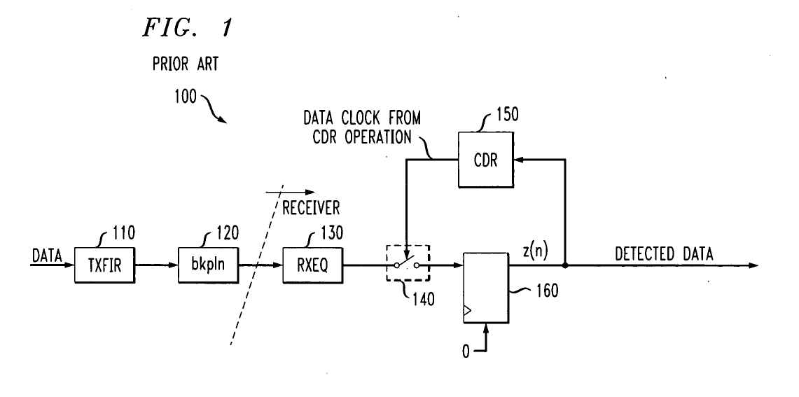

FIG. 1 is a block diagram of a conventional serializer/deserializer communication channel 100. The serializer/deserializer communication channel 100 has a channel impairment that is due, for example, to a physical transmission medium, such as a backplane or drive head in a magnetic recording system. As shown in FIG. 1, the data is transmitted through a backplane channel 120 after optionally being equalized or filtered through a transmit FIR filter (TXFIR) 110. After passing though the backplane 120, the analog signal may optionally be filtered or equalized by a receive equalizer (RXEQ) 130 which may consist, for example, of a continuous time filter. The analog signal out of the RXEQ 130 is sampled at the baud rate by a switch 140 using a sampling clock generated by a clock and data recovery circuit circuit 150 that recovers the clock from the received signal, in a known manner.

The phase of the analog waveform is typically unknown and there may be a frequency offset between the frequency at which the original data was transmitted and the nominal receiver sampling clock frequency. The function of the CDR 150 is to properly sample the analog waveform such that when the sampled waveform is passed through a data detector (or slicer) 160, the data is recovered properly despite the fact that the phase and frequency of the transmitted signal is not known. The CDR 150 is often an adaptive feedback circuit and the feedback loop must adjust the phase and frequency of the nominal clock to produce a modified recovered clock that can sample the analog waveform to allow proper data detection.

The output of the data detector 160 is used to update the phase of the sampling clock via the CDR 150 to appropriately recover any phase and frequency offsets between the transmitted data and the sampling clock.

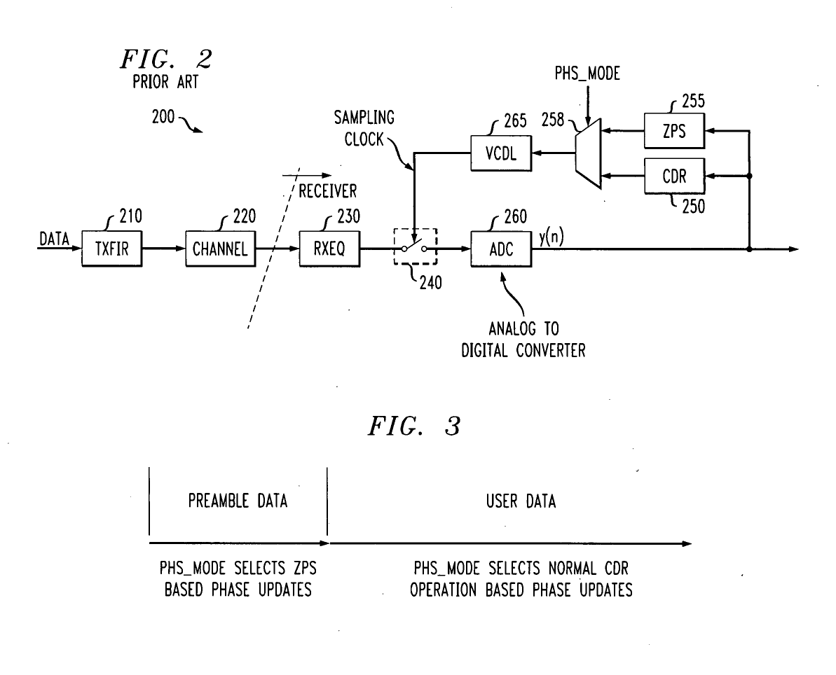

As previously indicated, zero phase start (ZPS) techniques have been used to improve the acquisition time. FIG. 2 is a block diagram of a communication channel 200 that employs a ZPS algorithm to obtain an initial estimate of the phase of the signal before the normal CDR operation commences. As discussed hereinafter, the ZPS algorithm 255 employed in FIG. 2 relies on relatively finely quantized amplitude domain signal samples from an analog-to-digital converter (ADC) 260.

As shown in FIG. 2, the data is transmitted through a backplane channel 220 after optionally being equalized or filtered through a transmit FIR filter (TXFIR) 210. After passing though the backplane 220, the analog signal may optionally be filtered or equalized by a receive equalizer (RXEQ) 230 which may consist, for example, of a continuous time filter. The analog signal out of the RXEQ 230 is sampled at the baud rate by a switch 240 using a sampling clock generated by a voltage controlled delay line (VCDL) 265. As discussed further below, the sampling clock generated by the VCDL 265 is based on the ZPS algorithm 255 or a clock/data recovery (CDR) circuit 250. An analog-to-digital converter 260 digitizes the sample and compares the digitized sample to an exemplary threshold of zero, using the recovered clock.

The phase of the analog waveform is typically unknown and there may be a frequency offset between the frequency at which the original data was transmitted and the nominal receiver sampling clock frequency. The function of the VCDL 265 is to properly sample the analog waveform such that when the sampled waveform is passed through the analog-to-digital converter 260, the data is recovered properly despite the fact that the phase and frequency of the transmitted signal is not known. The CDR 250 is often an adaptive feedback circuit and the feedback loop must adjust the phase and frequency of the nominal clock to produce a modified recovered clock that can sample the analog waveform to allow proper data detection.

The output of the analog-to-digital converter 260 is used to update the phase of the sampling clock via the CDR 250 or ZPS algorithm 255 to appropriately recover any phase and frequency offsets between the transmitted data and the sampling clock. As previously indicated, traditional ZPS techniques require relatively finely quantized amplitude domain signal samples from the analog-to-digital converter 260. The CDR 250 and ZPS circuitry 255 call for phase changes to the clock which may be implemented, for example, by the voltage controlled delay line (VCDL) or other means.

In certain applications, an a priori known preamble pattern 310 may be transmitted before the actual data 320, as shown in FIG. 3. Such a preamble pattern 310 may consist for example of a 2T pattern, which is the data sequence 1,1,0,0 repeated with a bit periodicity of 4T. The receiver may take advantage of such a preamble pattern to perform an initial phase estimate or zero phase start by which to quickly bring the recovered clock phase to a near optimal phase in a time which can be much smaller than what would have been needed by the main CDR control loop. Once the preamble is over, the normal CDR control loop can provide phase updates to the sampling clock. Thus, a multiplexer 258 serves to multiplex ZPS or normal CDR phase updates to the VCDL 265 which adjusts the recovered sampling clock phase. The multiplexer 258 is controlled by a phase mode signal, PHS_MODE. The PHS_MODE signal may be determined at the receiver side based, for example, on some a priori known protocol/handshaking scheme whereby the preamble is transmitted for a predefined time duration from when the system is started.

Alternatively, the PHS_MODE indicator could itself be detected based on a detection of the received data. For example, regardless of the initial phase or frequency, the periodicity of the received data could be noted within some tolerance and a periodicity matching that of the preamble would indicate presence of the preamble whereas a break in the periodicity would indicate the presence of actual user data. The alignment of the use of the ZPS 255 or phase updates from the CDR 250 is shown in FIG. 3.

Amplitude Domain ZPS

ZPS can be thought of as computing a dot product of a given number of periods of an arbitrarily sampled sine wave with an in-phase and quadrature (90 degrees out of phase) expected received samples of the sine wave. Let y[n] represent the received samples (as generated by the analog-to-digital converter). Let r[n] represent the in-phase component and r[n−1] will represent the quadrature component of the expected samples. Let w0[n] represent be the in-phase dot product and w1[n] the quadratuture dot product. Thus,

$$\begin{matrix}w 0 [ n ] = {\sum }_{k = 0}^{L - 1} y [ k ] r [ k ] & ( 1 ) \\ w 1 [ n ] = {\sum }_{k = 0}^{L - 1} y [ k ] r [ k - 1 ] & ( 2 )\end{matrix}$$

where L is the number of samples upon which the ZPS is calculated. The dot products w0[n] and w1[n] also represent an accumulation of integration of the received samples after modulation with the r[n]. Hence, the dot products will also be referred to as the ZPS accumulator values or ZPS integrator values. For a desired NRZ response equalized (or even for other equalized target systems such as various partial response systems) r[n] would be 1, 1, −1, −1, 1, 1, −1, −1 for L equal to eight and r[n−1] would be −1, 1, 1, −1, −1, 1, 1, −1.

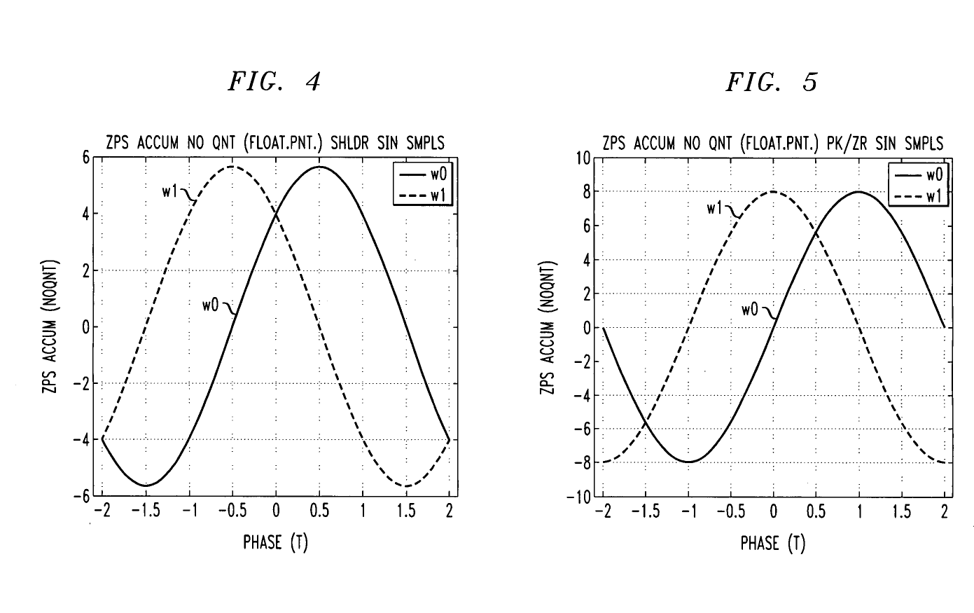

FIG. 4 illustrates the ZPS accumulator values w0[n] and w1[n] as a function of all possible input phases for r[n] corresponding to shoulder samples and L equal to 8. FIG. 5 illustrates the ZPS accumulator values w0[n] and w1[n] as a function of all possible input phases for r[n] corresponding to peak and zero samples and L equal to 16. The plots of FIGS. 4 and 5 are based on floating point values for y(n), with no ADC quantization error. With 5 or 6 bit resolution quantized input samples, for example, the error from amplitude quantization can be made relatively small.

The input phase in FIGS. 4 and 5 is with respect to the phase giving the desired samples. Since the dot product represents the phase angle between the received samples and the desired samples with the dot product I and Q components representing sine/cosine terms, the sampling phase error, Ø, can be computed with respect to the desired phase using an inverse sin or tan function:

$$∅ = atan ( \frac{w 0 [ n ]}{w 1 [ n ]} ) \qquad ( 3 )$$

By examining the sign of all the accumulated quantities, the appropriate sign of the phase adjustment which needs to be made can be selected based on the above calculation. FIG. 5 illustrates the calculations based on assuming that peak/zero samples were actually desired, i.e., r[n]=1, 0, −1, 0, 1, 0, −1, 0, . . . for L equal to 16. The computed Ø along with the correct sign can be used to adjust the phase of the data clock to move the sampling phase to the proper point. As would be apparent to a person of ordinary skill in the art, computing Ø would require accurate representations of w0[n] and w1[n] which would in turn require high resolution samples for y(n).

### Time Domain ZPS Using Binary Resolution Samples

As previously indicated, a number of receiver architectures do not employ an ADC, and provide only binary resolution amplitude samples. The present invention provides a time domain based ZPS algorithm that does not require finely quantized amplitude domain signal samples. The disclosed ZPS algorithm processes binary resolution sliced amplitude samples. As with most ZPS algorithms, the exemplary algorithm will require a modest amount of 2T pattern preamble (or another periodic preamble). Instead of doing a one shot calculation relying on high resolution amplitude samples, the disclosed algorithm performs a series of ZPS calculations after stepping/advancing the sampling clock with the available time resolution. Based on an accumulation of the binary samples for each clock phase, ZPS detection logic determines whether the sampling phase is correct. Once the logic determines that the phase is correct, no further phase advances are made and the normal CDR operation begins.

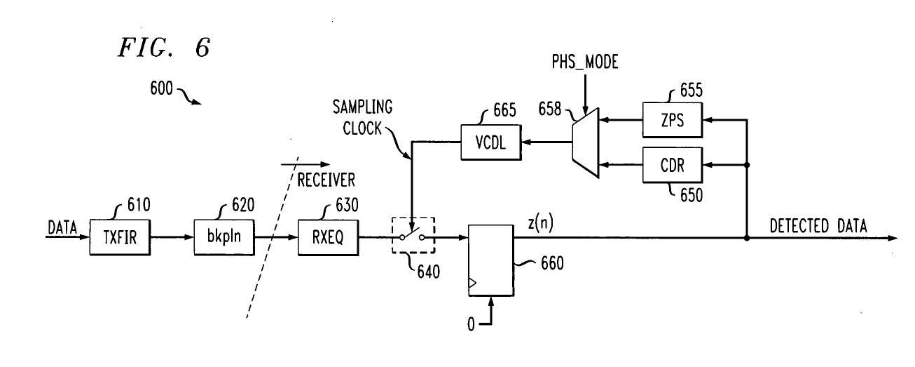

FIG. 6 is a block diagram of a serializer/deserializer communication channel 600 incorporating features of the present invention. The serializer/deserializer communication channel 600 has a channel impairment that is due, for example, to a physical transmission medium, such as a backplane or drive head in a magnetic recording system. In the exemplary implementation shown in FIG. 6, the data is transmitted through a backplane channel 620 after optionally being equalized or filtered through a transmit FIR filter (TXFIR) 610. After passing though the backplane 620, the analog signal may optionally be filtered or equalized by a receive equalizer (RXEQ) 630 which may consist, for example, of a continuous time filter. The analog signal out of the RXEQ 630 is sampled at the baud rate by a switch 640 using a sampling clock generated by a voltage controlled delay line (VCDL) 665. As discussed further below, the sampling clock generated by the VCDL 665 is based on a ZPS algorithm 655 or a clock/data recovery (CDR) circuit 650. A slicer (or latch) 660 digitizes the sample to a binary quantized value by comparing the sample to an exemplary threshold of zero, using the recovered clock.

The phase of the analog waveform is typically unknown and there may be a frequency offset between the frequency at which the original data was transmitted and the nominal receiver sampling clock frequency. The function of the VCDL 665 is to properly sample the analog waveform such that when the sampled waveform is passed through the slicer 660, the data is recovered properly despite the fact that the phase and frequency of the transmitted signal is not known. The CDR 650 is often an adaptive feedback circuit and the feedback loop must adjust the phase and frequency of the nominal clock to produce a modified recovered clock that can sample the analog waveform to allow proper data detection.

The output of the slicer 660 is used to update the phase of the sampling clock via the CDR 650 or ZPS algorithm 655 to appropriately recover any phase and frequency offsets between the transmitted data and the sampling clock. The CDR 650 and ZPS circuitry 655 call for phase changes to the clock which may be implemented, for example, by the voltage controlled delay line (VCDL) or other means.

As previously indicated, when a receiver implementation does not provide high resolution samples, such as 5 or 6 bits of quantization, but employs binary sliced data, the sine or inverse tangent look up discussed above to compute the required phase adjustment is not available. The present invention computes a weighted sum of the binary samples with the desired sine samples.

$$\begin{matrix}w 0 [ n ] = {\sum }_{k = 0}^{L - 1} z [ k ] r [ k ] & ( 4 ) \\ w 1 [ n ] = {\sum }_{k = 0}^{L - 1} z [ k ] r [ k - 1 ] & ( 5 )\end{matrix}$$

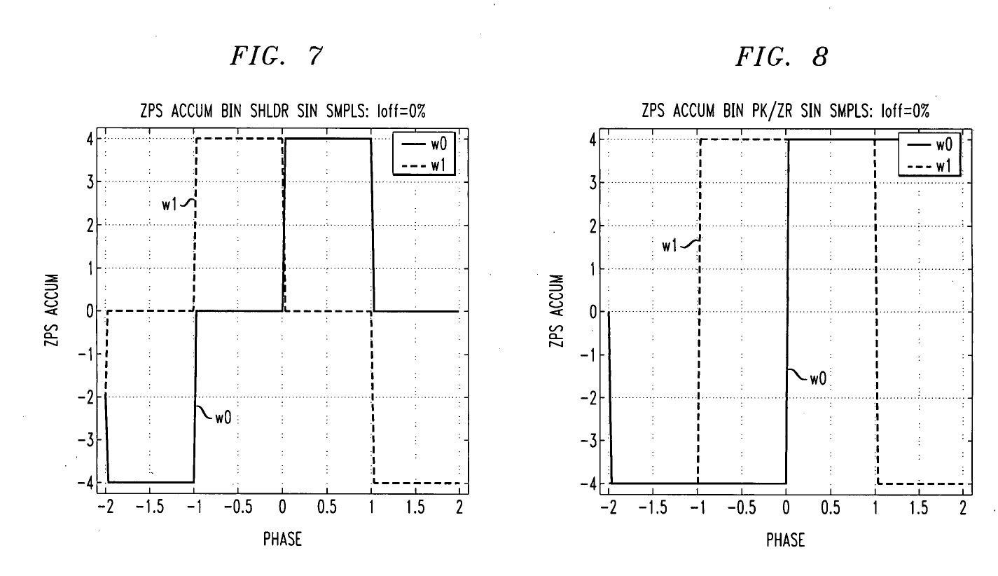

In equations (4) and (5), the input samples are denoted by a different symbol z[k] to emphasize that they are binary sliced samples. Instead of computing a phase adjustment output, the present invention determines whether or not the current phase is the correct phase based on examining these weighted sums. FIGS. 7 and 8, illustrate the ZPS accumulator values w0[n] and w1[n] as a function of the input phase for binary sliced input sample for shoulder samples and L equal to 8 (and clock quantization of T/32) and peak and zero samples and L equal to 16, respectively.

It is noted that when the input phase is correct (0 or an integer multiple of T), the accumulator values transition. For example, in the example of FIG. 7, the accumulator values change from 4 to 0 at the transition point. Therefore, whether the current phase is the correct baud rate phase can be determined by looking for these transitions. In other words, the present invention keeps advancing the phase on the clock until a transition in the accumulator values is detected (from 4 to 0, or from 0 to −4 in the example of FIG. 7). If a transition is not identified, the clock phase is advanced by a clock quantization step of, for example, T/16 or T/32, and the ZPS accumulator measurement is performed again. This is repeated until the correct sampling phase has been selected. The number of phase advances that are required to obtain the desired transition provides an indication of the phase offset.

Although may not be necessary to know which quadrant is being evaluated, the exact values of the accumulators can also indicate which of the four quadrants is being evaluated in the sine wave. The correct phase can be identified within the clock quantization accuracy.

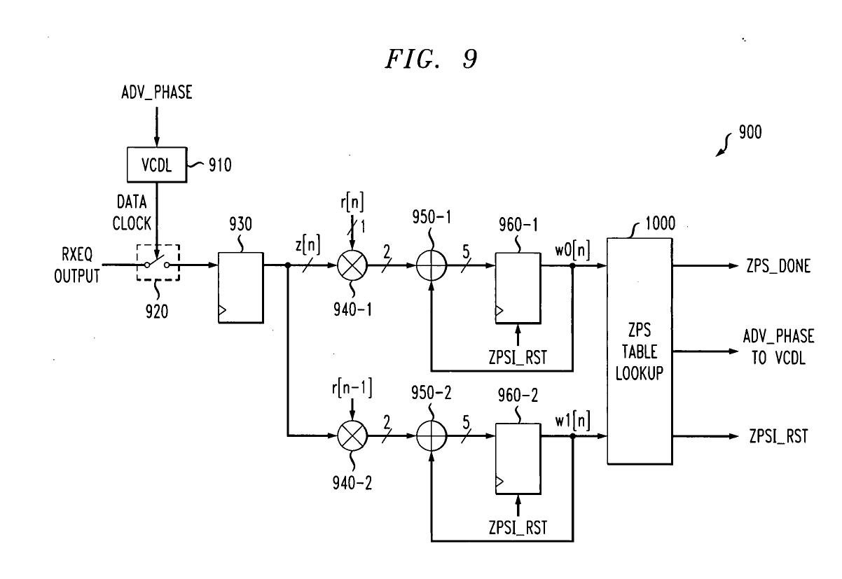

FIG. 9 is a block diagram of a portion of a serializer/deserializer communication channel 900 incorporating a time domain based ZPS calculation algorithm operating on binary samples in accordance with an embodiment of the present invention. As shown in FIG. 9, the analog signal, for example, out of the RXEQ 630 is sampled at the baud rate by a switch 920 using a sampling clock generated by a voltage controlled delay line (VCDL) 910, in a similar manner to FIG. 6.

A data detector 930 (or a slicer) digitizes the sample and compares the digitized sample to an exemplary threshold of zero, using the recovered clock. In a Digital Feedback Equalization (DFE) implementation, the switch 920 and slicer 930 are replaced with the sampled DFE output out of the DFE latches/logic.

The output of the slicer 930, z[n], is applied to a pair of multipliers 940. A first multiplier 940-1 multiplies the r[n] signal (in-phase component) and a second multiplier 940-2 multiplies the r[n−1] sequence (quadrature component). The multipliers 940 are of trivial implementation complexity because both inputs to the multipliers 940 are binary values. A pair of adders 950 and slicers 960 implement equations (4) and (5) to generate the accumulated dot products, w0[n] and w1][n].

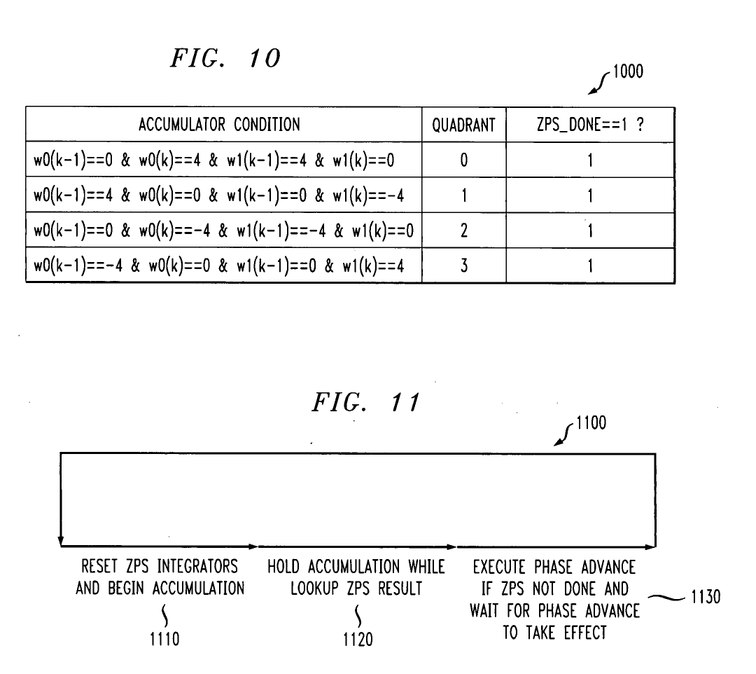

A ZPS lookup table logic 1000, shown in FIG. 10, is employed to process the values of w0[n] and w1[n] and determine when the ZPS process is complete. As shown in FIG. 10, the ZPS lookup table logic 1000 determines when ZPS_DONE equals one based on various conditions of the values of w0[n] and w1][n]. Generally, the ZPS lookup table logic 1000 is a table mapping of the accumulator transitions shown in FIG. 7.

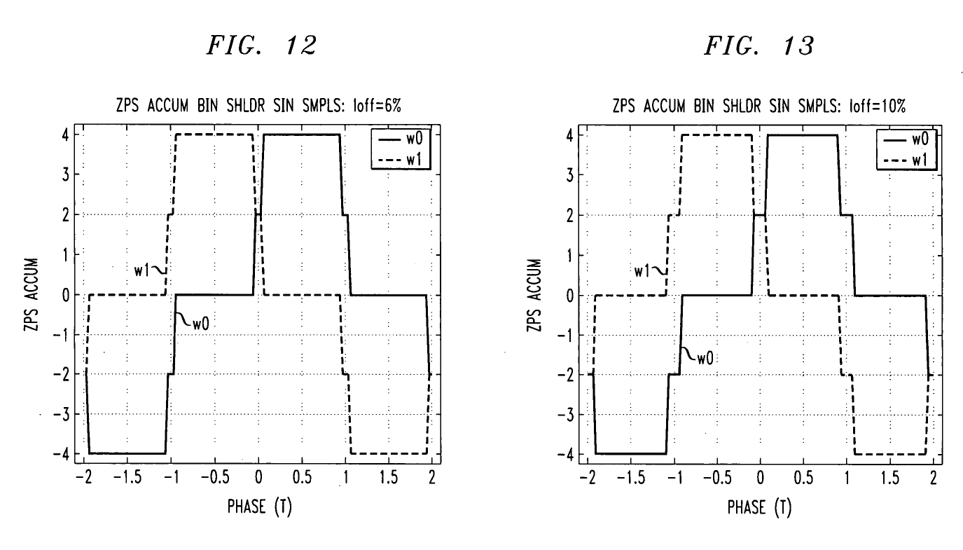

FIG. 11 is a flow chart describing an exemplary implementation of the ZPS algorithm 1100 incorporating features of the present invention. As shown in FIG. 11, the ZPS algorithm 1100 initially resets the ZPS integrators and begins accumulating during step 1110. The accumulation is held during step 1120 while the ZPS result is evaluated. Finally, the phase is advanced during step 1130 if the ZPS is not complete (as determined by accessing the ZPS lookup table 1000).

ZPS with Latch Offset

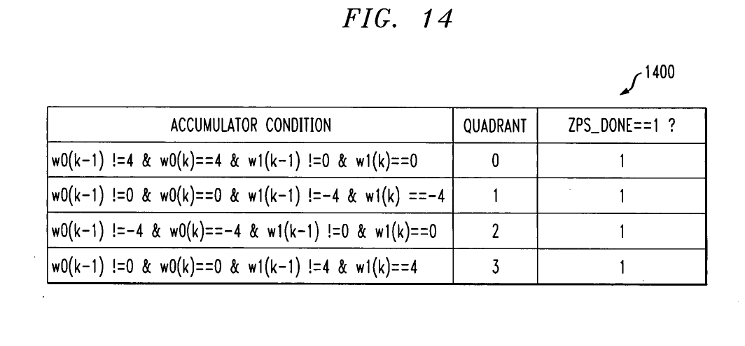

A variation of the present invention recognizes that in the presence of noise or latch offsets, the transitions may not be as crisp as shown in FIGS. 7 and 8, but will eventually transition to the strongest value. FIG. 12 illustrates the ZPS accumulator values w0[n] and w1[n] for a latch offset of 6% of the desired equalized 2T level, and FIG. 13 illustrates the ZPS accumulator values w0[n] and w1[n] for a latch offset of 10% of the desired equalized 2T level.

The ZPS lookup table 1000 of FIG. 10 is modified to the conditions shown in the table 1400 of FIG. 14 to accommodate the latch offsets. Rather than looking for a specific value for the previous accumulator value, the table 1400 looks to determine whether there was a transition to the final value. The presence of latch offsets will manifest itself as an additional ZPS timing error since the transitions will be detected with a less accurate time accuracy.

It is to be understood that the embodiments and variations shown and described herein are merely illustrative of the principles of this invention and that various modifications may be implemented by those skilled in the art without departing from the scope and spirit of the invention.

For example, the ZPS table lookup operation embodied in tables 1000, 1400 can be pipelined (although the CDR performance will degrade as the pipeline latency increases since there will be a frequency offset present as well as the phase offset). The blocks that must run at the full data rate are the two ZPS accumulators or integrators that integrate the binary input stream. For L equal to the width of the integrator, only three bits wide is needed to accommodate values in the range of −4 to 4. However, if this was still believed to be a bottleneck, an alternative implementation can be employed, based on matching the received sampling phase to the r[n] sequence corresponding to a peak/zero crossing. This would give two full data rate clock cycles for the integrator to complement each sample accumulation (see FIG. 8 for the accumulator values for this scenario). The logic tables for the ZPS lookup would change accordingly and when the process terminates, there is a T/2 offset from the correct phase for T/32 quantized clocks. Another T/2 phase adjustment distributed over 8 or 16 phase advances would put the sampling at the correct phase.

In a further variation, r[n] corresponding to the peak/zero samples are used, as above, but received samples based on the transition clock are used instead of the data clock. The transition clock is clock generated from the data clock that has been phase offset by T/2. In this manner, when the ZPS process terminates, the correct phase is obtained (rather than being T/2 from the correct phase).

We claim:

1. A method for obtaining a phase offset estimate from a data stream, comprising:
obtaining a binary sampled version of said data stream based on a clock;
accumulating a first dot product of said binary sampled version of said data stream and an ideal sequence;
accumulating a second dot product of said binary sampled version of said data stream and a delayed ideal sequence; and
adjusting a phase offset of said clock until said accumulated first and second dot product satisfy one or more predefined conditions.

2. The method of claim 1, wherein said predefined conditions comprise a transition of at least one of said accumulated first and second dot product.

3. The method of claim 1, wherein said predefined conditions comprise whether at least one of said accumulated first and second dot product transition to a final value.

4. The method of claim 1, wherein said ideal sequence is based on a shoulder sampling of said data stream.

5. The method of claim 1, wherein said ideal sequence is based on a peak/zero crossing sampling of said data stream.

6. The method of claim 1, wherein said delayed ideal sequence is delayed by one unit interval.

7. The method of claim 1, wherein said one or more predefined conditions are evaluated in a pipeline fashion.

8. A receiver for processing data received on a channel, comprising:
a data detector for obtaining a binary sampled version of said data stream based on a clock;
a first integrator for accumulating a first dot product of said binary sampled version of said data stream and an ideal sequence;
a second integrator for accumulating a second dot product of said binary sampled version of said data stream and a delayed ideal sequence; and
a clock source for generating said clock, wherein a phase offset of said clock is adjusted until said accumulated first and second dot product satisfy one or more predefined conditions.

9. The receiver of claim 8, wherein said predefined conditions comprise a transition of at least one of said accumulated first and second dot product.

10. The receiver of claim 8, wherein said predefined conditions comprise whether at least one of said accumulated first and second dot product transition to a final value.

11. The receiver of claim 8, wherein said ideal sequence is based on a shoulder sampling of said data stream.

12. The receiver of claim 8, wherein said ideal sequence is based on a peak/zero crossing sampling of said data stream.

13. The receiver of claim 8, wherein said delayed ideal sequence is delayed by one unit interval.

14. The receiver of claim 8, wherein said one or more predefined conditions are evaluated in a pipeline fashion.

15. A receiver for processing data received on a channel, comprising:
means for obtaining a binary sampled version of said data stream based on a clock;
means for accumulating a first dot product of said binary sampled version of said data stream and an ideal sequence;
means for accumulating a second dot product of said binary sampled version of said data stream and a delayed ideal sequence; and
means for generating said clock, wherein a phase offset of said clock is adjusted until said accumulated first and second dot product satisfy one or more predefined conditions.

16. The receiver of claim 15, wherein said predefined conditions comprise a transition of at least one of said accumulated first and second dot product.

17. The receiver of claim 15, wherein said predefined conditions comprise whether at least one of said accumulated first and second dot product transition to a final value.

18. The receiver of claim 15, wherein said ideal sequence is based on a shoulder sampling of said data stream.

19. The receiver of claim 15, wherein said ideal sequence is based on a peak/zero crossing sampling of said data stream.

20. The receiver of claim 15, wherein said delayed ideal sequence is delayed by one unit interval.
